(19) United States
(12) Patent Application Publication
(10) Pub. No.: US 2006/0031267 A1
(43) Pub. Date: Feb. 9, 2006

(54) Apparatus, system, and method for efficient recovery of a database from a log of database activities

(76) Inventors: Victor King Lim, San Jose, CA (US); David Wayne Moore, Morgan Hill, CA (US); F. Stephen Perry, San Jose, CA (US)

Correspondence Address: KUNZLER & ASSOCIATES, 8 EAST BROADWAY, SUITE 600, SALT LAKE CITY, UT, 84111, US

(21) Appl. No.: 10/911,803

(22) Filed: Aug. 4, 2004

(51) Int. Cl. G06F 17/30

(52) U.S. Cl. 707/202

(57) ABSTRACT

An apparatus, system, and method are disclosed for efficient recovery of a database from a log of database activities. A log of database activities is filtered into a first sequential data set. The remainder portion of the log is sorted into a second sequential data set. The first sequential data set and the second sequential data set are merged and written to the database. Allowing the sequential records to bypass a sort operation reduces the amount of time and the system resource overhead required for database recovery.

### BACKGROUND OF THE INVENTION

1. Field of the Invention

This invention relates to data storage and more particularly relates to an apparatus, system, and method for efficient recovery of a database from a log of database activities.

2. Description of the Related Art

In the field of data management, system administrators commonly work with database and data storage systems. Database and data storage systems allow users and software applications to store information in a logical, orderly, and accessible format. Generally, a database includes a database management system that manages access to the information stored on a data storage device. The information stored in these database and data storage systems should be readily accessible for modification or reference, because applications or processes requiring access to the information cannot function otherwise. Due to the importance of the information, database system administrators ensure that the stored information is constantly accessible and quickly available.

A reorganization process may be used to ensure that the information is stored in an efficient manner. As users and applications store information, referred to as data, on the database, the data may become spread within the storage device such that retrieval is less efficient. A reorganization process may be used to restore order to the data storage device for more efficient operation. The reorganization process runs through the database sequentially, groups the data according to a linking identifier, and rewrites the data to the storage system. The reorganization process consolidates disparate data to improve efficiency. If there is a large amount of data stored on the data storage system, the online reorganization process may take up to several days to fully reorganize the data.

It is desirable that the client applications be able to update the database concurrently with the updates being made by the reorganization process. Modifications made to records in the database, as used herein, are referred to as updates, and may include move, copy, or write operations. Updates can be made sequentially, as with the reorganization process, or non-sequentially as with standard asynchronous write operations from client applications. Under normal operating conditions, details of the updates along with information, metadata, about the update including a time stamp, sequencing information, and an identifier of the process initiating the update are recorded as log records in a log.

If the storage system fails, the records in the log are used to recover the database to the point of failure. Conventional recovery processes require that the log records be in sorted order for the database to be recovered sequentially. If the number of records in the log is extremely large, the sorting process can tax system resources. If a reorganization process was in progress at the time of the failure, an extremely large number of log records may exist, and therefore tax system resources to an even greater extent. Furthermore, in consideration of the amount of time required to reorganize the database, it is desirable that the database be recovered to the point of failure, including all updates made by the reorganization process. It is desirable that the number of log records that are passed through the sort process be reduced without compromising the integrity of the recovery process.

From the foregoing discussion, it should be apparent that a need exists for an apparatus, system, and method that efficiently recovers a database from a log of database activities. Beneficially, such an apparatus, system, and method would decrease recovery time and resource impact by reducing the number of log records to be sorted, while still including in the recovery the updates made by both the reorganization process and any other process whose updates were recorded in the log.

### SUMMARY OF THE INVENTION

The present invention has been developed in response to the present state of the art, and in particular, in response to the problems and needs in the art that have not yet been fully solved by currently available database recovery devices. Accordingly, the present invention has been developed to provide an apparatus, system, and method for efficient recovery of a database from a log of database activities that overcome many or all of the above-discussed shortcomings in the art.

The apparatus to efficiently recover a database from a log of database activities is provided with a logic unit containing a plurality of modules configured to functionally execute the necessary steps of separating a log data set into a first sequential data set, sorting the remaining log data set into a second sequential data set, merging the first sequential data set and the second sequential data set into a recovery data set, and writing the recovery data set to the database. These modules in the described embodiments include a filtering module, a sorting module, a merging module, and a writing module.

Preferably, the filtering module separates a log data set for a database into a first sequential data set. In one embodiment, the filtering module filters the log records that satisfy an indirect sequence identifier. The indirect sequence identifier may identify a database application that originated the log record. The indirect sequence identifier may be collocated with the log record. Identifying the application that originated the log records also indicates the sequential nature of the records, because some applications perform operations sequentially, and some do not. The indirect sequence identifier is considered indirect, because it contains no specific information that can be directly used to determine the sequence of the records.

The sorting module sorts the remaining log data set into a second sequential data set. In one embodiment, the sorting module is further configured to determine a sequence for the log data set based on a direct sequence identifier for each log record. A direct sequence identifier is considered direct, because it contains specific information that can be directly used to determine the sequence of the records. The direct sequence identifier may comprise at least one attribute selected from a group consisting of a database data set identifier, a relative byte address identifier, a data set sequence number, a lock sequence number, and a time stamp.

The merging module merges the first sequential data set and the second sequential data set into a logical recovery data set. In one embodiment, the merging module is configured to sequentially merge log records from the first sequential data set and from the second sequential data set into a database. The sequential order may be determined by a direct sequence identifier within the log data records. In one embodiment, the merging module is configure to selectively pass the records from the first sequential data set and the second sequential data set, in response to a sequence defined by a direct sequence identifier.

Preferably, the writing module writes the recovery data set to the data base. In one embodiment, the writing module is configured to write the recovery data set to the database in a single pass.

In one embodiment, the apparatus includes a verification module configured to verify a sequence of the first sequential data set. The verification module may compare a direct sequence identifier of a log record with a direct sequence identifier for a previous log record in the first sequential data set, and send non-sequential log records to the unsorted log data set to be sorted.

A system of the present invention is also presented to efficiently recover a database from a log of database activities. The system, in one embodiment, includes a database, one or more log data sets, a recovery apparatus comprising a filtering module, a sorting module, and a merging module, and a writing apparatus. The data base may be configured to process concurrent sequential updates and non-sequential updates. In one embodiment, the log data set comprises log records associated with sequential updates and non-sequential updates. In addition to these embodiments, the system performs substantially the same functionality as the apparatus described above.

A method of the present invention is also presented for efficient recovery of a database from a log of database activities. The method in the disclosed embodiments substantially includes the steps necessary to carry out the functions presented above with respect to the operation of the described apparatus and system.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for efficient recovery of a database from a log of database activities;

FIG. 2 is a schematic block diagram illustrating one embodiment of an apparatus for efficient recovery of a database from a log of database activities;

FIG. 3 is a detailed schematic block diagram illustrating one embodiment an apparatus for efficient recovery of a database from a log of database activities;

FIG. 4 is a schematic flow chart diagram illustrating one embodiment of a method for efficient recovery of a database from a log of database activities;

FIG. 5 is a detailed schematic flow chart diagram illustrating one embodiment of a method for efficient recovery of a database from a log of database activities; and

FIG. 6 is a schematic block diagram illustrating one embodiment of merging log records.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

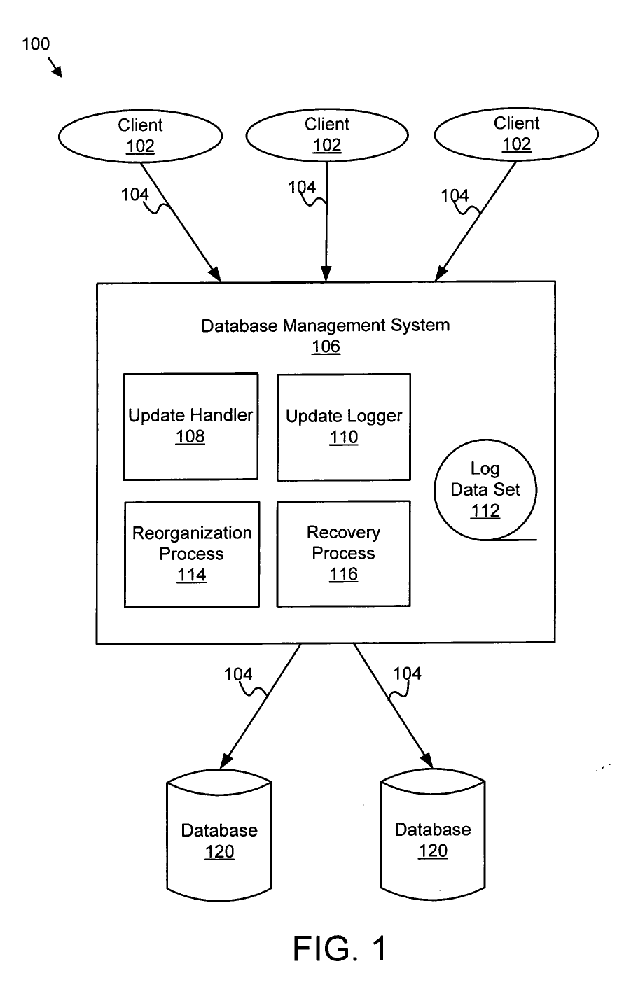

FIG. 1 is a schematic block diagram of a system 100 for efficient recovery of a database from a log of database activities. The system 100 includes clients 102 of the database, a database management system (DBMS) 106, and one or more databases 120. Updates 104 from the clients are sent to the DBMS 106 for processing. The DBMS 106 performs the updates 104 on the appropriate database 120.

Clients 102 may comprise any application, workstation, server, other computer device, or software module that stores or retrieves records from a database 120. In one embodiment, a client 102 may comprise a software program running on a workstation in communication with the DBMS 106 and associated databases 120 via a network connection. In this embodiment, the client 102 may store program data on the database 120. New records, deleting commands, and changes to existing records are sent to the DBMS 106 in the form of updates 104. Updates 104 from a client 102 are generally non-sequential, because multiple applications may be running simultaneously, each making concurrent updates, and multiple clients 102 may update the database 120 simultaneously.

The database management system 106 may include an update handler 108, an update logger 110, a log data set 112, a reorganization process 114, and a recovery module 116. The updates 104 are managed by an update handler 108. In one embodiment, the update handler 108 controls data flow to and from the clients 102. The update handler 108 also sends the updates 104 to the database 120.

Certain processes may generate sequential updates 104. A reorganization process 114 is one example of a process that generates sequential updates 104. The reorganization process 114 groups data stored on a database 120, to reduce lookup time, increase usable storage space, and increase data reliability. In one embodiment, the reorganization process 114 consolidates disparate database records into logical blocks of data, and writes the blocks of data sequentially to a database 120, in the form of individual record updates 104. An alternative embodiment of a process that generates sequential updates 104 may include a change accumulation process.

In one embodiment, an update logger 110 records each update 104 made to a database 120 so that the updates 14 can be recovered if needed. The updates 104 typically comprise a mix of sequential updates and non-sequential updates. A reorganization process 114, or the like, may generate sequential updates 104. Clients 102, processes on the DBMS 106, and the like may generate non-sequential updates 104. In one embodiment, the update logger 110 generates log records of the updates 104. The log records include metadata such as direct sequence identifiers and indirect sequence identifiers. In one embodiment, the update logger 110 stores the log records in a log data set 112.

The log data set 112 typically includes log records of sequential updates 104 and non-sequential updates 104, as well as the metadata such as direct sequence identifiers and indirect sequence identifiers associated with the updates 104. The update logger 110 may store the log data set 112 on a tape drive, a solid-state memory device, a storage disk, or other data storage device. In one embodiment, the update logger 110 generates the log data set 112 in the same order updates 104 are made to the database 120. In one embodiment, the metadata is collocated with the records. In an alternative embodiment, the metadata may be located in separate location or data structure. The recovery module 116 may use the log data set 112 to repair the database 120 in case of failure.

The recovery module 116 recovers a database 120 in the event of a database failure. A database 120 failure may be caused by a hardware failure in the storage system. If at the time of failure, both a reorganization process 114 and concurrent client 102 updates are active, the log data set 112 typically includes log records for non-sequential updates 104 and sequential updates 104.

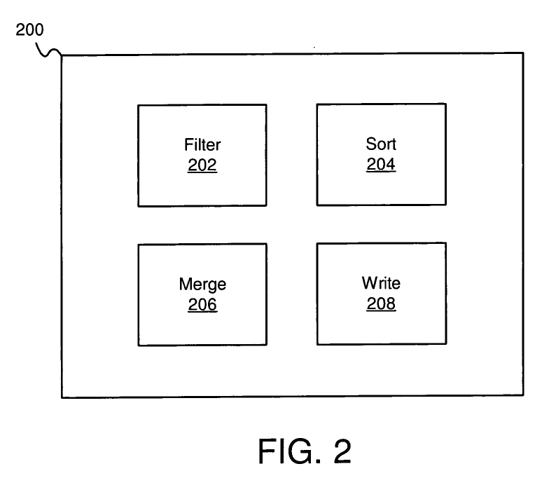

FIG. 2 illustrates one embodiment of an apparatus 200 for efficient recovery of a database 120 from a log 112 of database activities. In one embodiment, the apparatus 200 includes a filtering module 202, a sorting module 204, a merging module 206, and a writing module 208. In one embodiment, the recovery module 116 on the DBMS 106 is the apparatus 200.

The filtering module 202 separates records from a log data set 112 into a first sequential data set. One of ordinary skill in the art will readily recognize that filtering removes records satisfying the filter. In one embodiment, the filtering module 202 filters the log data set 112 based on an indirect identifier. An indirect identifier is an identifier that indirectly indicates a disposition for sequence for the log records. One embodiment of an indirect identifier is an indicator of the process that generated the update 104 which produced the corresponding log record. If the process that generates sequential updates 104, such as a reorganization process 114 originated the log records, then the log records are presumed to be grouped in sequential order. Log records generated by the reorganization process 114 and other processes that generate sequential updates, are separated from the log data set 112. In one embodiment, the separated log records are combined into a first sequential data set. The first sequential data set bypasses the sorting module 204.

In one embodiment, the sorting module 204 sorts the remaining log data set 112 into a second sequential data set. The sorting module 204 typically sorts the log data set 112 according to a direct sequence identifier. In one embodiment, the sorting module 104 uses a direct sequence identifier, such as a time stamp or index number, which identifies the sequence of a log record in relation to other log records in the log data set 112. Alternatively, the direct sequence identifier and associated sequence may be alphabetical, numeric, chronological, or the like.

In one embodiment, the merging module 206 merges a first sequential data set and a second sequential data set into a recovery data set. The merging module 206 merges the first sequential data set and the second sequential data set in order to more efficiently write the recovery records in the ordered recovery data set to the database 120. Merging the first sequential data set and the second sequential data set into a recovery data set allows the writing module 208 to write more consolidated recovery records to the database 120.

The writing module 208 writes the recovery records to the database 120. The writing module 208 may write complete data blocks to the data base. In another embodiment, the writing module 208 may write each record to the database 120 separately. In one embodiment, the writing module 208 writes directly to the database 120. In an alternative embodiment, the writing module 208 writes the recovery records to a cache or memory on the DBMS 106 to be sent to the database 120 by the update handler 108. In another alternative embodiment, the writing module 208 sends the recovery records to the update handler 108 which directly updates 104 the database 120.

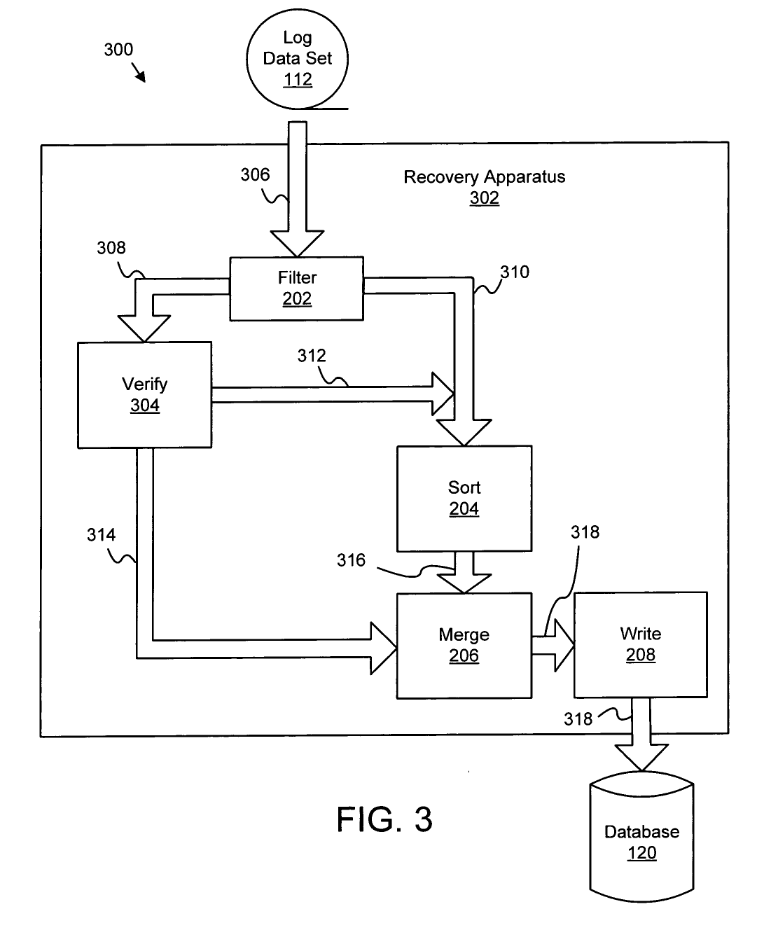

FIG. 3 illustrates a detailed block diagram of an apparatus 300 for efficient recovery of a database 120 from a log of database activities. The block diagram of the apparatus 300 includes the modules described above in relation to FIG. 2, as well as a verification module. Arrows represent data sets at various stages in the recovery apparatus 302. First the recovery apparatus 302 reads a log data set 306 read into the recovery apparatus 302 from the log data set 112. The filtering module 202 produces a first sequential data set 308 and an unsorted log data set 310.

In one embodiment, the apparatus 300 includes a verification module 304 which verifies a sequence of the first sequential data set 308. The verification module 304 may verify the sequence of the first sequential data set 308 by comparing a direct sequence identifier of a log record with a direct sequence identifier of a previous log record in the first sequential data set 308. Log records of the first sequential data set 308 found to be out of sequence are sent to the unsorted log data set 310.

In one embodiment, the verified first sequential data set indicated by arrow 314 bypasses the sorting module 204, and is sent directly to the merging module 206. The unsorted log data set 310 is sorted by the sorting module 204. The sorting module 204 rearranges the unsorted log data set 310 to form the second sequential data set 316. The recovery apparatus 302 sorts the remaining log data set 112 and recovers the database 120 more efficiently, because a large portion of the log records bypass the sorting module 204. The verified first sequential data set 314 is able to bypass the sorting module 204, because the associated records are generated by the reorganization process 114, and thus are already in sequential order.

In one embodiment, verified first sequential data set indicated by arrow 314 and the second sequential data set 316 are sent to the merging module 206. The merging module 206 combines the verified first sequential data set 314 and the second sequential 316 data set into the recovery data set 318. The merging module 206 sends the recovery data set 318 to the writing module 208. In one embodiment, the writing module 208 writes the recovery data set 318 to the data base 120.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

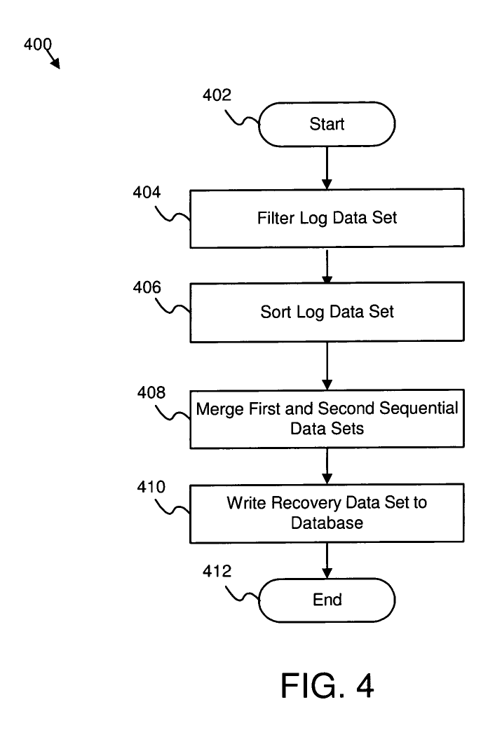

FIG. 4 illustrates a schematic flow chart diagram of a method 400 for efficient recovery of a database 120 from a log of database activities. In one embodiment, the method 400 begins 402 by filtering 404 the log records in the log data set 306. The filtering module 202 separates the log data set 306 into a first sequential data set 308 and an unsorted log data set 310 according to an indirect sequence identifier. The sorting module 204 then sorts the unsorted log data set 310 according to a direct sequence identifier. In one embodiment, the resulting data set comprises the second sequential data set 316. The first sequential data set 308 bypasses the sorting module 204. The merging module 206 merges 408 the first sequential data set 308 and the second sequential data set 316. The writing module 208 then writes 410 the resulting recovery data set 318 to the database 120.

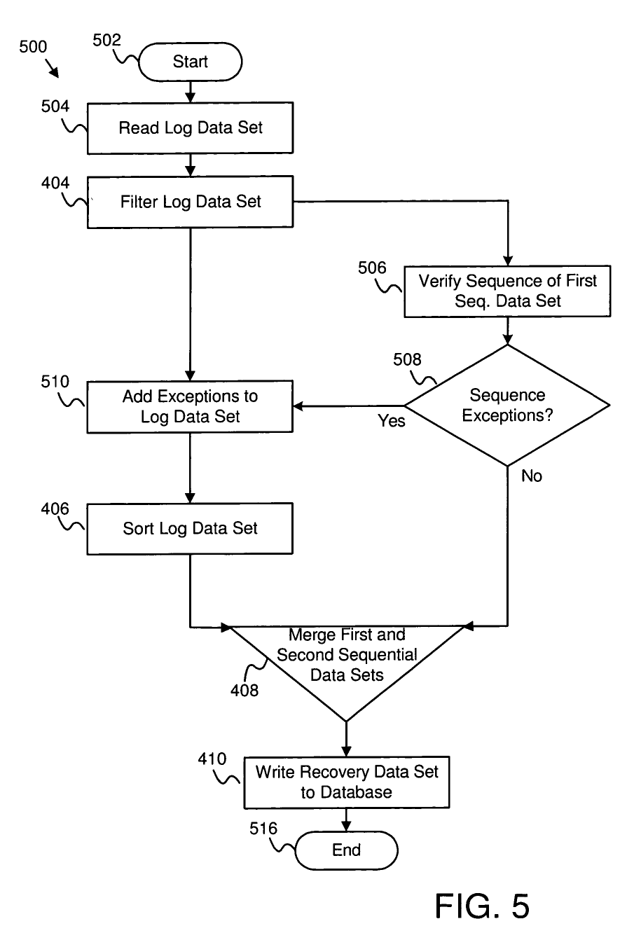

FIG. 5 illustrates a detailed schematic flow chart diagram of one embodiment of a method 500 for efficient recovery of a database 120 from a log of database activities. The method 500 starts 502 with reading 504 in the log data set 306 from the log data set 112. The filtering module 202 filters 404 the log data set 306. In one embodiment, the filtering module 202 separates the log data set 306 into a first sequential data set 308 and a remainder portion of the log data set 306.

In one embodiment, a set of parallel operations may be performed subsequent to filtering 404 the log data set 306. The verification module 304 verifies 506 a sequence of the first sequential data set 308. If the sequence of the records is correct 508, then the sorting module 204 does not sort 406 the verified first sequential data set 314. If the sequence of the records is incorrect 508, then the exception data set 312, comprising the records that do not satisfy a sequence, are combined 510 with the unsorted log data set 310. The sorting module 204 sorts 406 the unsorted log data set 310.

Upon completion of the sort 406 operation, the merging module 206 merges 408 records from the second sequential data set 316 with records from the first sequential data set 314 and passes the records to the write module 208. In an alternative embodiment, the merging module 206 does not create 512 the base data blocks until the sort 406 operation is complete. The writing module 208 then writes 410 the resulting recovery data set 318 to a database 120.

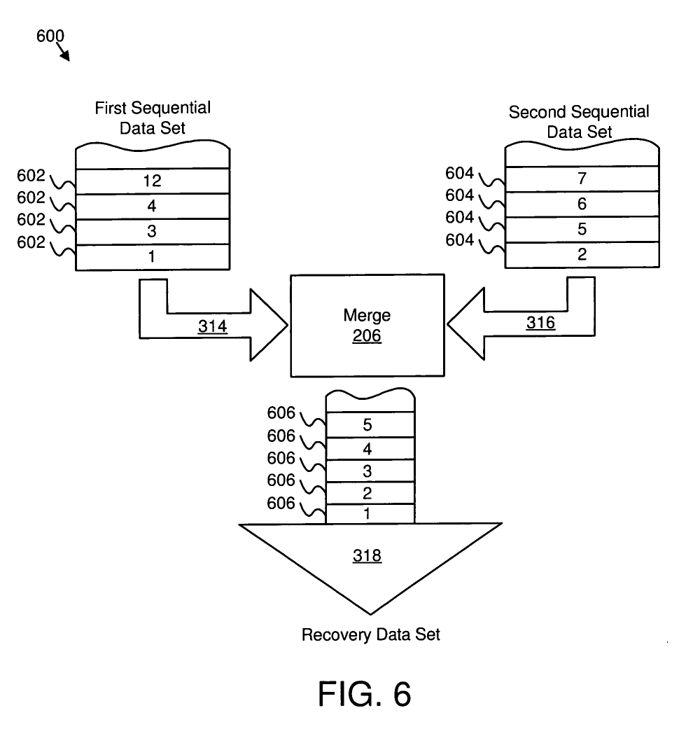

FIG. 6 illustrates a schematic block diagram illustrating one embodiment 600 of merging sequential log records. In this embodiment 600, the first sequential data set 314 comprises records 602 with a direct sequence identifier. The second sequential data set 316 also comprises records 604 with a direct sequence identifier. The merge module 206 sequentially merges the records 602 from the first sequential data set 314 and records 604 from the second sequential data set 316 into a recovery data set 318. The recovery data set 318 comprises records 606 from both the first sequential data set 314 and the second sequential data set 316 ordered according to the direct sequence identifier.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for efficient recovery of a database from a log of database activities, the apparatus comprising:
a filtering module configured to separate log records from a log data set for a database into a first sequential data set;
a sorting module configured to sort the remaining log data set into a second sequential data set;
a merging module configured to merge the first sequential data set and the second sequential data set into a recovery data set; and
a writing module configured to write the recovery data set to the database.

2. The apparatus of claim 1, wherein the filter module is further configured to filter the log records that satisfy an indirect sequence identifier.

3. The apparatus of claim 2, wherein the indirect sequence identifier identifies a database application that originated the log record.

4. The apparatus of claim 1, further comprising a verification module configured to verify a sequence of the first sequential data set.

5. The apparatus of claim 4, wherein the verification module is further configured to compare a direct sequence identifier of a log record with a direct sequence identifier for a previous log record in the first sequential data set, and sends non-sequential log records to the unsorted log data set.

6. The apparatus of claim 1, wherein the sorting module is further configured to determine a sequence for the log data set based on a direct sequence identifier for each log record, the sequence identifier comprising at least one attribute selected from a group consisting of a database data set identifier, a relative byte address identifier, a data set sequence number, a lock sequence number, and a time stamp.

7. The apparatus of claim 1, wherein the merging module is further configured to sequentially merge log records from the first sequential data set and from the second sequential data set into a database.

8. The apparatus of claim 7, wherein the sequence is determined by a direct sequence identifier within the log data records.

9. The apparatus of claim 1, wherein the writing module is further configured to write the recovery data set to the database in a single pass.

10. The apparatus of claim 1, wherein the merging module is further configured to selectively pass records from the first sequential data set and the second sequential data set, in response to a sequence defined by a direct sequence identifier.

11. A system to efficiently recover a database from a log of database activities, the system comprising:
a database configured to process concurrent sequential updates and non-sequential updates;
a log data set comprising log records associated with sequential updates and non-sequential updates;
a recovery apparatus configured to sort the log data set, the recovery apparatus comprising;
a filtering module configured to separate log records from a log data set for a database into a first sequential data set;
a sorting module configured to sort the remaining log data set into a second sequential data set;
a merging module configured to merge the first sequential data set and the second sequential data set into a recovery data set; and
a writing apparatus configured to write the recovery data set to the database.

12. The system of claim 11, wherein the recovery apparatus is further configured to filter the log records that satisfy an indirect sequence identifier.

13. The system of claim 12, wherein the indirect sequence identifier identifies a database application that originated the log record.

14. The system of claim 13, further configured to verify a sequence of the first sequential data set.

15. The system of claim 14, further configured to compare a direct sequence identifier of a log record with a direct sequence identifier for a previous log record in the first sequential data set, and sends non-sequential log records to the unsorted log data set.

16. The system of claim 15, wherein the recovery apparatus is further configured to determine a sequence for the log data set based on a direct sequence identifier for each log record, the sequence identifier comprising at least one attribute selected from a group consisting of a database data set identifier, a relative byte address identifier, a data set sequence number, a lock sequence number, and a time stamp.

17. The system of claim 16, wherein the recovery apparatus is further configured to sequentially merge log records from the first sequential data set and from the second sequential data set into a database.

18. The system of claim 17, wherein the sequence is determined by a direct sequence identifier within the log data records.

19. The system of claim 18, wherein the writing apparatus is further configured to write the recovery data set to the database in a single pass.

20. The system of claim 19, wherein the recovery apparatus is further configured to selectively pass records from the first sequential data set and the second sequential data set, in response to a sequence defined by a direct sequence identifier.

21. A signal bearing medium tangibly embodying a program of machine-readable instructions executable by a digital processing apparatus to perform operations for efficient recovery of a database from a log of database activities, the operations comprising:
an operation to separate log records from a log data set for a database into a first sequential data set;
an operation to sort the remaining log data set into a second sequential data set;
an operation to merge the first sequential data set and the second sequential data set into a recovery data set; and
an operation to write the recovery data set to the database.

22. The signal bearing medium of claim 21, wherein the operation to filter log records is further configured to filter the log records that satisfy an indirect sequence identifier.

23. The signal bearing medium of claim 22, wherein the indirect sequence identifier identifies a database application that originated the log record.

24. The signal bearing medium of claim 21, wherein the instructions further comprise an operation to verify a sequence of the first sequential data set.

25. The signal bearing medium of claim 24, wherein the operation to verify a sequence compares a direct sequence identifier of a log record with a direct sequence identifier for a previous log record in the first sequential data set, and sends non-sequential log records to the unsorted log data set.

26. The signal bearing medium of claim 21, wherein the sort operation is determines a sequence for the log data set based on a direct sequence identifier for each log record, the sequence identifier comprising at least one attribute selected from a group consisting of a database data set identifier, a relative byte address identifier, a data set sequence number, a lock sequence number, and a time stamp.

27. The signal bearing medium of claim 21, wherein the merge operation further comprises sequentially merging log records from the first sequential data set and from the second sequential data set into a database.

28. The signal bearing medium of claim 27, wherein the sequence is determined by a direct sequence identifier within the log data records.

29. The signal bearing medium of claim 21, wherein the operation to write further comprises writing the recovery data set to the database in a single pass.

30. The signal bearing medium of claim 21, wherein the operation to merge further comprises selectively passing records from the first sequential data set and the second sequential data set, in response to a sequence defined by a direct sequence identifier.
